(19) United States
(12) Patent Application Publication
(10) Pub. No.: US 2011/0132879 A1
(43) Pub. Date: Jun. 9, 2011

(54) CONNECTING ELECTRICAL PARTS

(76) Inventors: Yuhsuke Matsumoto, Kanagawa (JP); Eiki Oosawa, Kanagawa (JP); Tatsumi Tsuchiya, Kanagawa (JP); Hideto Imai, Kanagawa (JP); Tatsushi Yoshida, Kanagawa (JP)

(21) Appl. No.: 12/961,989

(22) Filed: Dec. 7, 2010

(30) Foreign Application Priority Data
Dec. 8, 2009 (JP) 2009-278859

(51) Int. Cl. B23K 9/04

(52) U.S. Cl. 219/76.1

(57) ABSTRACT

A method for connecting electrical parts The method includes retaining a piece of metal within a nozzle, supplying inert gas to the nozzle, and irradiating the retained piece of metal with a light source while the supplied inert gas flows from apertures in the nozzle. The metal is melted by the light source. The method also includes ejecting the melted metal from the nozzle by the supplied inert gas onto electrical parts.

### CROSS-REFERENCE TO RELATED APPLICATION

This application claims priority from the Japanese Patent Application No. 2009-278859, filed Dec. 8, 2009, the disclosure of which is incorporated herein in its entirety by reference.

### BACKGROUND

Typically, to enable reflow of a solder ball positioned between two connecting parts, the solder ball is positioned precisely between the parts. However, if the parts are very small it is difficult to properly position the solder ball. Moreover, it is common for the solder ball to roll during the reflow process. The solder ball thus has to be frequently repositioned, resulting in a loss of manufacturing efficiency.

### BRIEF DESCRIPTION OF THE DRAWINGS

FIGS. 1A-C illustrate examples of a head gimbal assembly.

FIGS. 2-5 illustrate examples of a device for connecting together electrical components.

FIG. 6 illustrates an example of a method for connecting together electrical components.

FIG. 7A-FIG. 11D illustrate examples of a solder ball retention unit.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Various types of device which uses media such as optical discs, magnetic disks or opto-magnetic disks are available as data storage devices. Amongst these, hard disk drives (HDD) have become widely used as storage devices for computers. Nor is the use of HDDs limited to computers, as they are also now used in image recording and playback devices, car navigation systems, digital cameras and the like.

HDDs are provided with a head slider which accesses the magnetic disk and an actuator which retains the head slider and moves the head slider over the magnetic disk by oscillation. The actuator has a suspension, the head slider being fixed to this suspension. The head slider is able to float above the magnetic disk due to the balance between viscosity of the air flowing between the head slider and the rotating magnetic disk and the force applied to the head slider by the suspension.

In one embodiment, there is a method of manufacture for a head gimbal assembly. This method transports a piece of metal to the nozzle. This piece of metal is retained within the nozzle, and the supply of inert gas is commenced to the nozzle. A light source (e.g., a laser) irradiates the retained piece of metal while causing the supplied inert gas to flow from apertures formed in the nozzle. The metal melted by the light source is ejected from the nozzle with the supplied inert gas, causing it to adhere to both parts. The two parts are then connected together through the hardening of the molten metal. Accordingly, blockage of the ejection port of the nozzle is prevented and there is a suitable connection between the parts using the metal. Moreover, the inert gas flows from the apertures in the direction of the two parts which improves wettability.

In various embodiments, the inert gas flows from apertures which are formed, at least in part, on the inflow side of the position in which the piece of metal and the inner surface of the nozzle are in contact. Also, the inert gas is flows from apertures which extend to the ejection outlet for the molten metal. As such, the inert gas is enabled to effectively flow downward. Additionally, oxidation of the metal is prevented and wettability improved.

The retained piece of metal is irradiated with a laser beam while inert gas is made to flow from a plurality of apertures formed in the nozzle.

In one embodiment, the piece of metal is retained in the nozzle by being retained on surfaces which slope inward in the direction in which the piece of metal flows outward. Accordingly, it is easier for the molten metal to flow and to reliably prevent blockage of the ejection outlet for the nozzle.

In another embodiment, the solder ball is retained by a plurality of claws separated around the periphery by a plurality of apertures extending to the ejection outlet for the molten metal.

In a further embodiment, a device causes molten metal to adhere between two connecting parts in a head gimbal assembly. The two parts are connected together by hardening of the metal.

The device includes a transportation unit which transports the piece of metal and a nozzle. The nozzle includes a retaining section which retains the piece of metal transported from the transportation unit, an ejection outlet which ejects the piece of metal towards the two connecting parts, and apertures from which an inert gas flows. The device also includes an inert gas supply device which supplies an inert gas into the nozzle, and a laser device which melts the piece of metal by irradiating the metal with a laser beam as inert gas flows from the apertures after the inert gas supply device has commenced supplying inert gas into the nozzle.

An embodiment of the invention will now be described. To make the description more clear, descriptions and drawings may be abbreviated or simplified as appropriate. Moreover, identical elements within the drawings are keyed identically, and repeated descriptions will be omitted as necessary for the sake of clarity. The description of the embodiment uses a hard disk drive (HDD) as an example of a disk drive. The embodiment is characterized in a technology for connecting parts together which employs a piece of metal for the connecting parts in the head gimbal assembly (HGA). In one embodiment, the piece of metal is spherical. Gold or solder can be considered as examples of material for the piece of metal. The following description refers to the connection of parts using a solder ball.

In various embodiments, a solder ball is used for connecting together the connecting parts for the gimbal and the connecting parts for the head slider. In addition, a solder ball is applied in an HGA with a micro-actuator to connect together connecting parts of the head slider and the connecting parts for the micro-actuator. In one such embodiment, a solder ball is used for connecting together the connecting parts of the micro-actuator and the connecting parts for the gimbal.

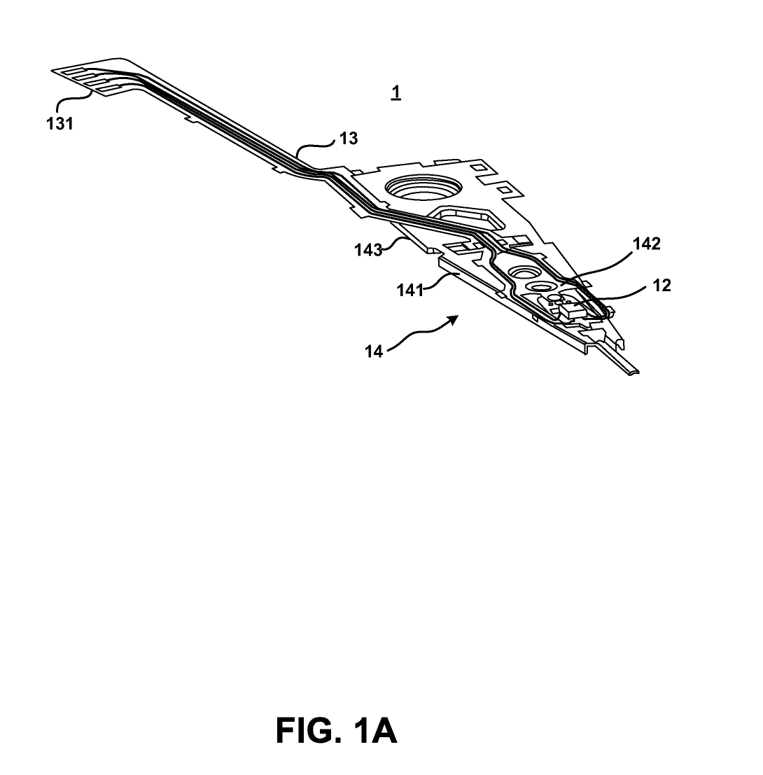

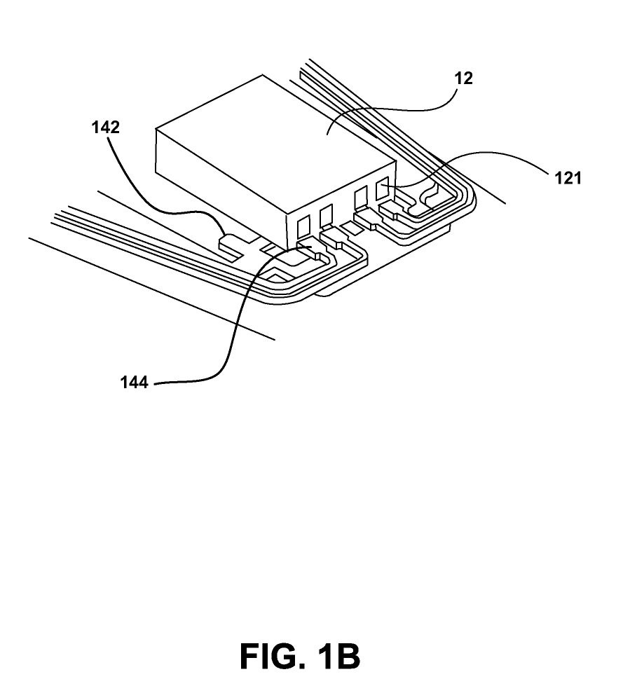

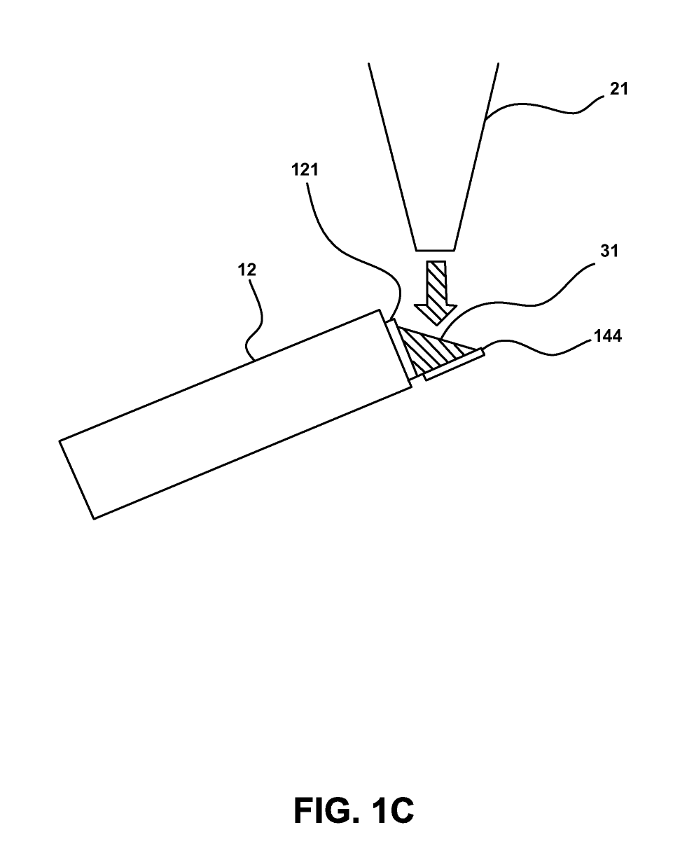

FIG. 1A depicts an oblique view of an example of HGA 1 mounted within an HDD. FIG. 1B is an enlarged diagram of the vicinity of the front end of head slider 12, showing the situation before connecting parts 144 of the suspension and connecting parts 121 of the slider are connected together. HGA 1 is provided with head slider 12, wiring 13, and suspension 14. Head slider 12 comprises a slider and a head element on the slider. The head element has a magneto resistance read head and an electromagnetic induction write head. It should be noted that the head element may have either a magneto resistance head or a write head.

Suspension 14 is constructed with gimbal 142 fixed to the side of load beam 141 which retains head slider 12, and mounting plate 143 fixed to the rear of the side of load beam 141 which retains head slider 12. Load beam 141 has the function of a spring which generates a fixed load to balance out the flotation force on head slider 12. Gimbal 142 supports head slider 12 where changes in the position of head slider 12 cannot be prevented. Furthermore, a gimbal tank is formed in gimbal 142. Head slider 12 is then fixed to the gimbal tank.

Trace 13 makes an electrical connection between head slider 12 and the preamp IC (not shown). Trace 13 is formed with insulating sheets provided to prevent contact between the plurality of lead wires. End 131 is one end of wiring 13 that is connected to the substrate on which preamp IC is located. Suspension connecting part 144 is formed at the other end of trace 13 on the side of head slider 12, as shown in FIG. 1B. In the example shown in FIG. 1B, there are four suspension parts 144. Suspension connecting parts 144 and the same number of slider connecting parts 12 are formed on the front end surface of head slider 12.

As shown in FIG. 1C, each of suspension connecting parts 144 and slider connecting parts 121 are connected together using solder 31. Suspension connecting parts 144 and slider connecting parts 121 are positioned adjacent to each other at a fixed angle (approximately 90° in this example). The soldering device of the embodiment is provided with nozzle 21. The solder emerging from the tip of this nozzle and dropping down between suspension connecting parts 144 and slider connecting parts 121 in a molten state, causes suspension connecting parts 144 and slider connecting parts 121 to adhere together. By this means, solder 31 connects these parts together electrically and physically. Accordingly, improvement in the productivity of manufacture of HGAs and the manufacture of HDDs which use an HGA occurs.

In contrast, in conventional technology, a solder ball is positioned between a suspension connecting part and a slider connecting part with the solder being melted to connect the two parts together.

The manufacture of an HDD begins with the manufacture of head slider 12. Suspension 14 is then manufactured separately to head slider 12. The manufacture of suspension 14 is done by manufacturing gimbal 142, load beam 141, and mounting plate 143. In various embodiments, gimbal 142, load beam 141, and mounting plate 143 are fixed together by laser spot welding or the like. Gimbal 142 may be formed using a photolithographic process or an etching process, and wiring 13 may also be formed together with the stainless steel gimbal body.

HGA 1 is manufactured by mounting head slider 12 on suspension 14. Thereafter, an arm and a VCM coil are fixed on HGA 1, and a head stack assembly (HSA), an assembly of the actuator and head slider 12, is manufactured. In addition to the manufacture of the HSA, a top cover is fixed to the base after fitting a spindle motor, a magnetic disk and the like on the base. The HDD is then completed by writing servo data into the magnetic disk and fitting the control circuit.

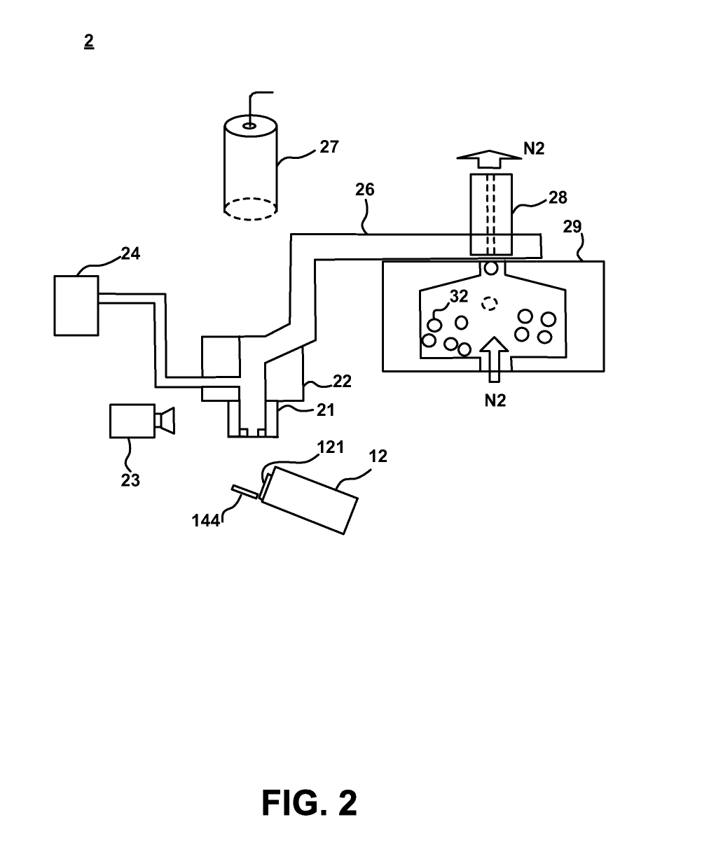

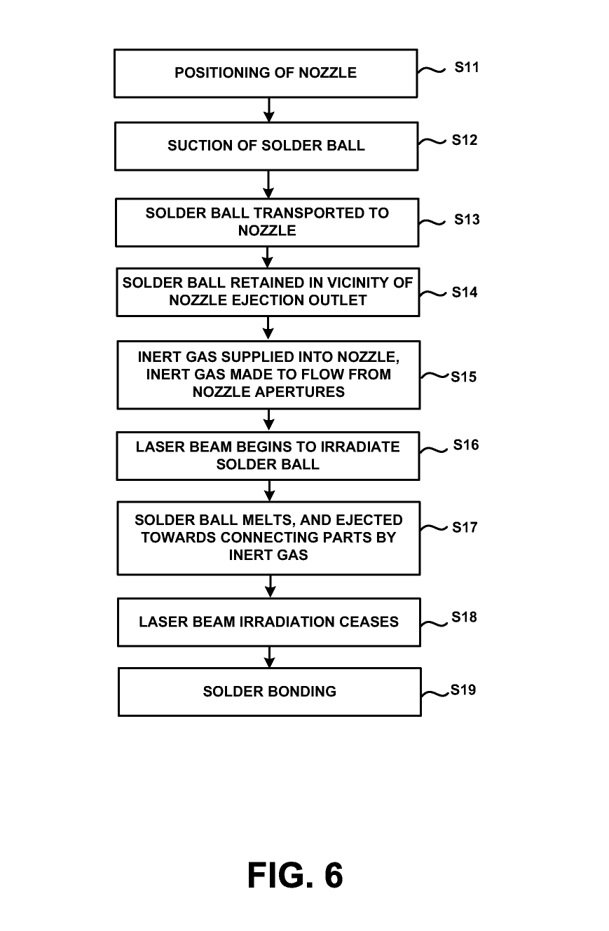

The process of connecting together suspension connecting parts 144 and slider connecting parts 121 in the process of manufacturing HGA 1 of the embodiment will now be described in more detail. FIGS. 2-5 are schematic diagrams illustrating the soldering device and the process of soldering which enables suspension connecting parts 144 and slider connecting parts 121 to be connected together. FIG. 6 is a flowchart showing the overall process of soldering.

The flow of the process for connecting together head slider 12 and suspension 14 will now be described with reference to the schematic diagrams in FIGS. 2-5 and the flowchart in FIG. 6. As shown in FIG. 2, soldering device 2, which is the HGA manufacturing device, first positions nozzle 21 into the position at which suspension connecting parts 144 and slider connecting parts 121 are to be connected together (S11 in FIG. 6).

Soldering device 2 is provided with a control device (not shown in the diagram). This control device controls the constituent elements of soldering device 2 and carries out the process of soldering. Soldering device 2 moves nozzle 21, retained by nozzle holder 22, toward HGA 1 (before completion), and positions it relative to connecting parts 121, 144 together. The tip of nozzle 21 is moved close to the two parts 121, 144 in a position facing them. In one embodiment, nozzle 21 is moved relative to HGA 1. In another embodiment, HGA 1 is moved relative to nozzle 21 (nozzle holder 22).

Solder ball 32 is removed by suction part 28 from solder ball supply device 29 in which solder balls 32 are stored (S 12). Solder ball supply device 29 blows solder balls 32 up from the bottom by blowing out gas (e.g., inert gas, typically nitrogen). An opening is provided on the top of solder ball supply device 29. A solder ball 32 which has been blown up is ejected from this opening. The ejected solder ball 32 is then sucked along suction part 28 positioned at this opening.

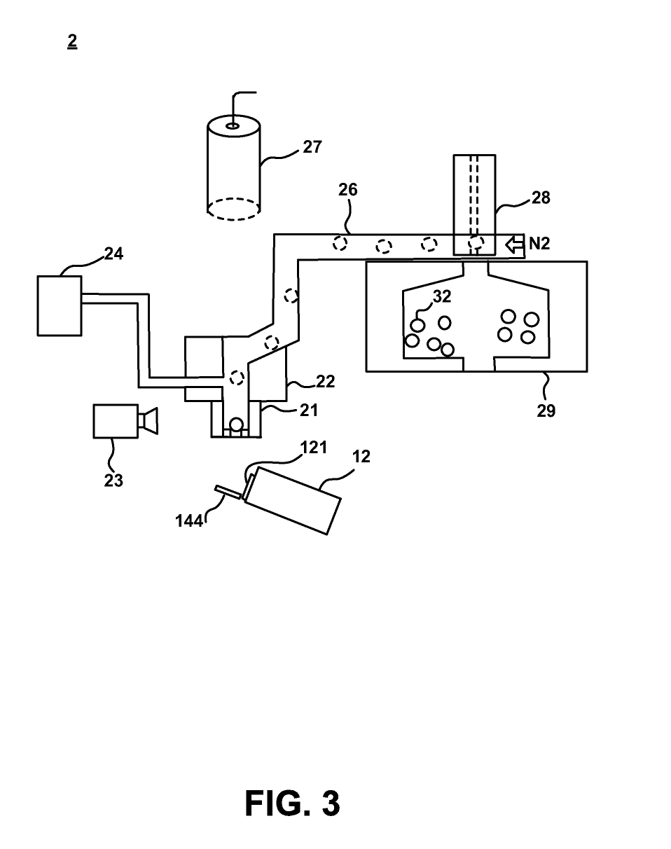

When solder ball 32 is in position, suction part 28 moves it upwards away from the opening. By this means, solder ball 32 is transferred to solder ball transportation pipe 26. As shown in FIG. 3, inert gas is made to flow within solder ball transportation tube 26 toward nozzle holder 22. Suction part 28 releases solder ball 32 within solder ball transportation tube 26. Solder ball 32 moves along solder ball transportation tube 26 with the flow of inert gas, and enters nozzle 21 via nozzle holder 22 (S 13).

Transportation tube 26 and nozzle holder 22 comprise solder ball 32 transportation unit. The transportation unit which transports solder ball 32 to nozzle 21 is not limited to the structure in this embodiment, and may have any structure. For example, solder ball 32 may be dropped into nozzle holder 22 through the rotation of suction part 28 after being picked up from solder ball supply device 29. In this way, the need for solder ball transportation tube 26 in FIG. 2 is not required.

Solder ball 32 drops into nozzle 21 through the flow of inert gas and gravity. In one embodiment, the direction of motion (downward) of solder ball 32 (the direction of the path) is vertical, but need not always be arranged this way. As shown in FIG. 3, nozzle 21 retains solder ball 32 which has dropped down to the vicinity of its ejection outlet (S 14). The mechanism for retaining the solder ball in nozzle 21 will be described later. Solder ball 32 which has dropped down within nozzle 21 is stopped by a solder ball retention structure, and retained there.

Soldering device 2 is provided with camera 23 which photographs solder ball 32 retained in nozzle 21. Soldering device 2 uses this image to confirm the number of solder balls retained. Moreover, in response to the first solder ball retained, the image is used to start the supply inert gas (typically nitrogen gas) to nozzle 21. Where two or more solder balls are retained, soldering device 2 withdraws the retained solder ball to the inlet side, and transfers a new solder ball 32 from solder ball supply device 29.

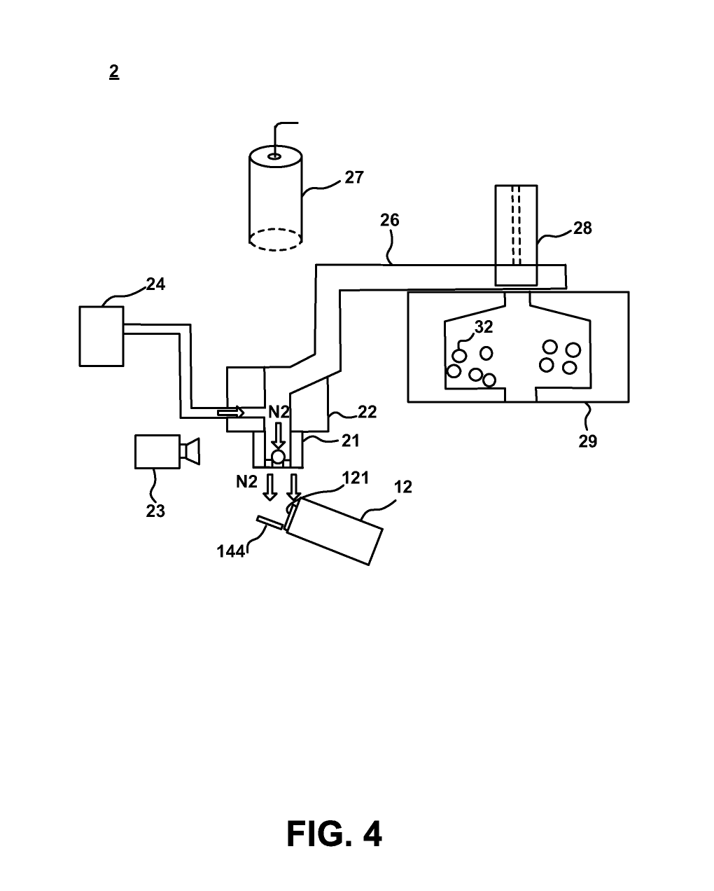

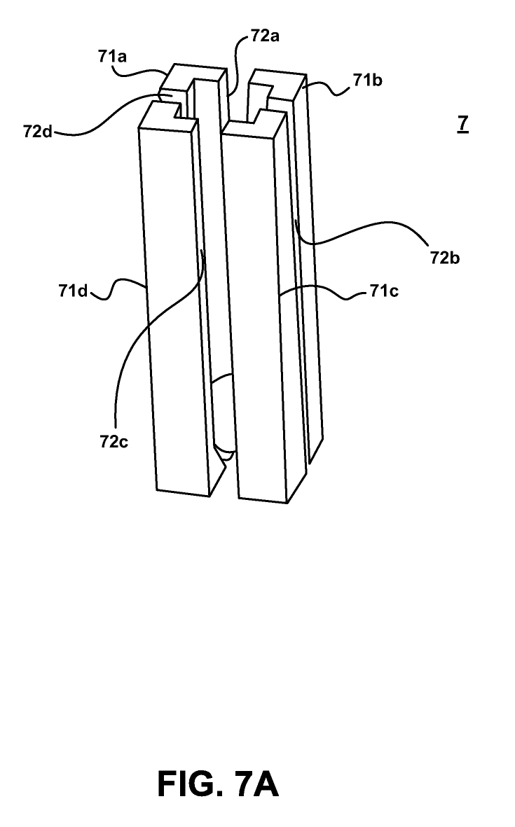

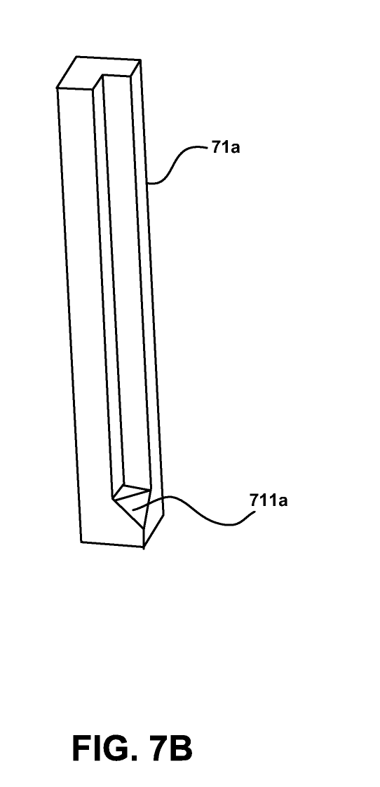

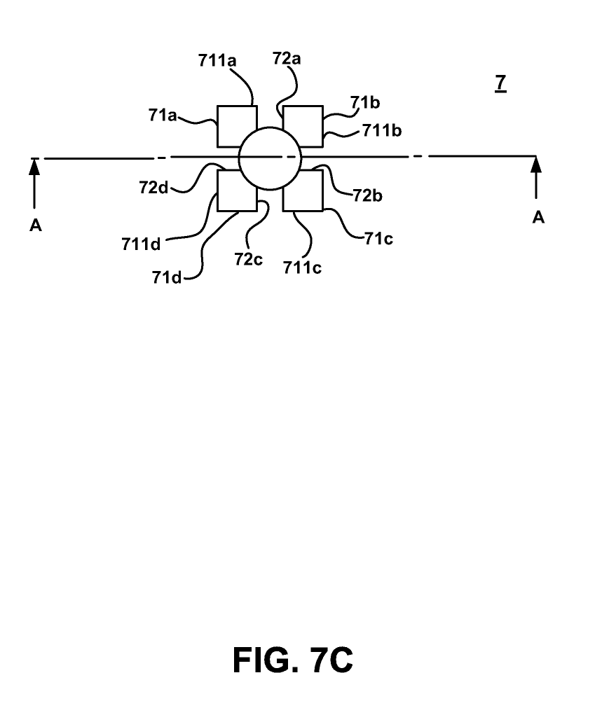

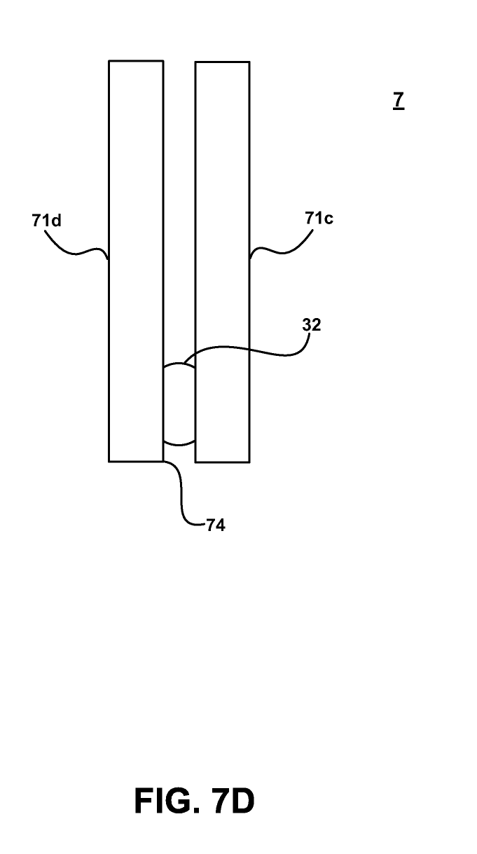

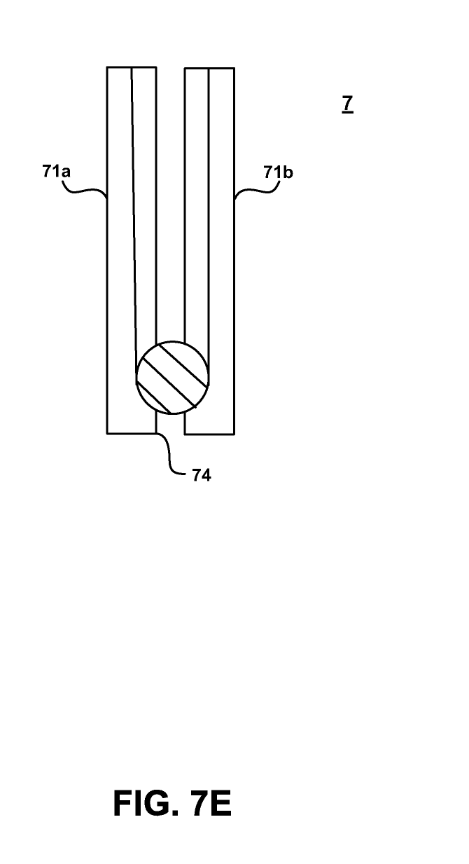

As shown in FIG. 4, inert gas supply device 24 supplies inert gas to nozzle 21 via piping which connects with nozzle holder 22 (S 15). The inert gas flows within the piping and nozzle holder 22 from inert gas supply device 24 into nozzle 21. In various embodiments, the piping may be connected to nozzle 21, or soldering device 2 may supply inert gas to nozzle 21 via solder ball transportation tube 26. Nozzle 21 of the embodiment has apertures in the vicinity of the solder ball retention unit in addition to the solder ball ejection outlet (see FIG. 7A-FIG. 11D). Thus, the inert gas flows within nozzle 21 and out of the nozzle through the apertures in nozzle 21.

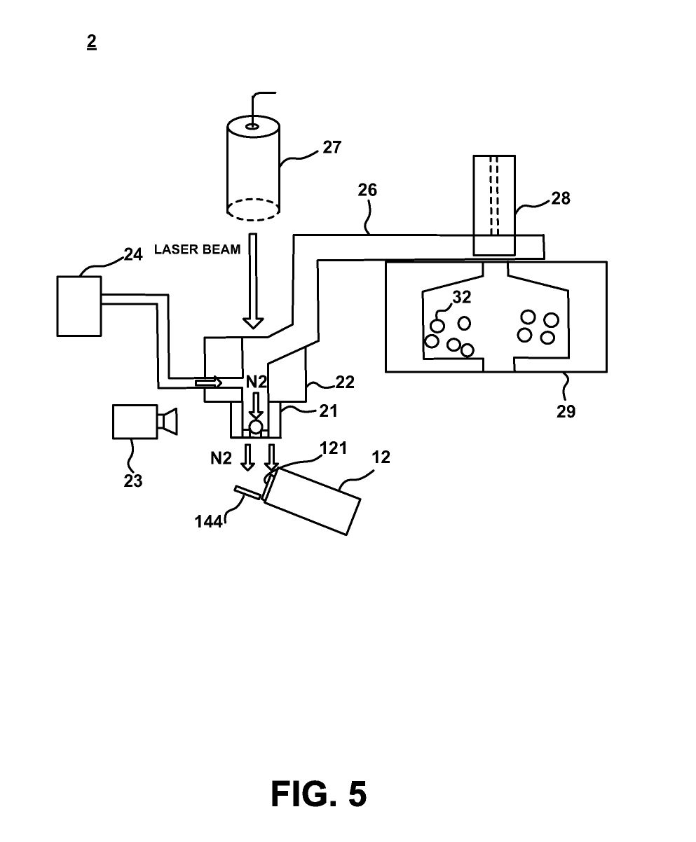

As shown in FIG. 5, soldering device 2 irradiates a laser beam onto the retained solder ball 32 using laser device 27 (S 16) while solder ball 32 is retained in nozzle 21 and inert gas flowing within nozzle 21. Solder ball 32 is melted by the laser beam and subsequently progresses toward the outlet from the inlet side of nozzle 21. The molten solder is expelled by the inert gas in the direction of connecting parts 121, 144 from the ejection outlet for nozzle 21 (S 17).

Laser device 27 ceases to irradiate a laser beam when the solder has been ejected (S 18). It should be appreciated that laser device 27 can be any light source generating a light that is able to melt solder ball 32. The laser beam irradiation ceases before the molten solder adheres to suspension connecting parts 144 and slider connecting parts 121, or alternatively continues slightly after it has become adhered. The solder which has dropped down onto connecting parts 121, 144 in a molten state and adhered to them then hardens, connecting together connecting parts 121, 144 (S 19).

As described above, soldering device 2 causes inert gas to flow within nozzle 21 before irradiation with the laser beam. This nozzle 21 has apertures through which the inert gas flows out, and there is no excessive buildup of pressure within nozzle 21 even where solder ball 32 is retained near the ejection outlet. When solder ball 32 is melted by the laser beam, the molten solder is simultaneously ejected towards connecting parts 121, 144 from nozzle 21 due to the compressed inert gas (flow of inert gas). In this way, there is no time difference present between the melting of the solder and its ejection, the molten solder is unlikely to remain within nozzle 21, and does not tend to block the solder retention unit.

As there is an inert gas atmosphere at least present on the inlet side of solder ball 32, it is possible to prevent oxidation of the melting solder ball 32 with a laser beam. In one embodiment, solder ball 32 is kept in an inert gas atmosphere both on the inflow and outflow sides. In another embodiment, the inert gas which flows from the inert gas outflow apertures in nozzle 21 flows to the outflow at side of solder ball 32. In a further embodiment, the shape and position of the inert gas outlet apertures allow the inert gas flowing outward so that solder ball 32 is kept within an atmosphere of inert gas on both the inlet side and the outlet side.

The molten solder adheres to connecting parts 121, 144. The molten solder then hardens on connecting parts 121, 144 to connect them together. To ensure a suitable wettability for the solder on connecting parts 121, 144, connecting parts 121, 144 are held within an inert gas atmosphere at the time that the solder adheres. In one embodiment, the inert gas flowing from the outflow apertures in inert gas of nozzle 21 flows onto connecting parts 121,144, and connecting parts 121, 144 are kept in an atmosphere of inert gas during the time that the molten solder adheres and hardens. By designing the position and shape of the apertures for the outflow of inert gas appropriately, it is possible to have the inert gas flowing out so that connecting parts 121, 144 are kept in an atmosphere of inert gas.

The solder ball retention unit in nozzle 21 will now be described with reference to FIG. 7A-FIG. 11D. In one embodiment, the solder ball retention unit is formed of transparent material. Through this means, the structure of nozzle 21 enables the structure within the solder ball retention unit to be easily checked. Moreover, having the solder ball retention unit formed of glass or ceramic rather than metal makes it difficult for the solder to adhere.

FIGS. 7A-7E illustrate embodiments of a structure for the solder ball retention unit. Solder ball retention unit 7 is provided with four claws 71a-71d. Claws 71b-71d are fixed parts which do not move. In FIGS. 7A-7E, FIG. 7A is an oblique view of solder ball retention unit 7, and 7B is an oblique view of claw 71a. FIG. 7C is a plan view of solder ball retention unit 7, FIG. 7D is a lateral view of solder ball retention unit 7, and FIG. 7E a cross-section through the line A-A in FIG. 7C.

The four claws 71a-71d are separated by four slits (apertures) 72a-72d. The four slits 72a-72d penetrate to the outside from the inside of solder ball retention unit 7. The four slits 72a-72d are respectively positioned between adjacent claws in the peripheral direction. In one embodiment, claws 71a-71d join together in an upper area not shown in the diagram, with nozzle 21 formed of one continuous part.

The region surrounded by claws 71a-71d (excluding slits 72a-72d) is the pathway for solder ball 32, this pathway being connected with the outside of nozzle 21 via slits 72a-72d. With this structure, the cross-section of the pathway which extends in the direction through which the solder drops (the vertical direction, the direction along which the laser beam is irradiated) is rectangular. In other words, the respective inner surfaces of claws 71a-71d which comprise the inner wall of the pathway comprise two surfaces at right angles to one another. The inner surfaces of claws 71a-71d may also be curved. In this example, the outer surfaces of claws 71a-71d are respectively formed from two surfaces at right angles to one another.

As shown in the oblique view of claw 71a in FIG. 7B, claw 71a is provided with sloping surface 711a on its inner surface (on the exposed surface within the pathway). The other claws 71b-71d have an identical shape to claw 71a, and claws 71b-71d are respectively provided with sloping surfaces 711b-711d. The four sloping surfaces hold solder ball 32 as it drops down, retaining it. Solder ball 32 comes to rest on (and is retained by) these four sloping surfaces 711a-711d. In one embodiment, the four sloping surfaces 711a-711d are plane surfaces respectively rather than curves. By this means, solder ball 32 is in point contact respectively with sloping surfaces 711a-711d.

Sloping surface 711a slopes in the direction in which solder ball 32 (molten solder) drops, and approaches the center of the pathway as it progresses towards the outflow side. The other three sloping surfaces 711b-711d have identical slopes. These sloping surfaces cause the inner diameter of the pathway to narrow as it approaches solder ejection outlet 74, with part of the downflow side (lower side) of solder ball 32 being retained by the four sloping surfaces. Thus, as solder ball 32 is retained on sloping surfaces, the molten solder can easily flow to the outside with the flow of inert gas, further reducing the possibility of solder remaining within solder ball retention unit 7 as the molten solder is expelled by the flow of inert gas.

Solder ball retention unit 7 is provided with solder ejection outlet 74 at its tip (not including slits 72a-72d). The minimum diameter of this solder ejection outlet 74 is less than the diameter of solder ball 32. In the structure of this example, the maximum diameter is also smaller than the diameter of solder ball 32. Solder ball 32 retained by claws 71a-71d melts in the laser beam, and is blown out from solder ejection outlet 74. In FIG. 7A-7E the retained solder ball 32 appears to be in contact with each of side surfaces 72a-72d which extend vertically, but in the actual device solder ball 32 is separated from them, and is retained by the sloping surfaces on the downflow side. This ensures a margin of error to allow solder ball 32 to pass through the pathway.

As described with reference to the flowchart in FIG. 6, soldering device 2 commences the supply of inert gas before irradiation of the laser beam while solder ball 32 is retained in nozzle 21. In addition to being blown against the retained solder ball 32, inert gas passes through slits 72a-72d and flows outside from nozzle 21. The solder melted by the laser beam is pushed by the flow of inert gas, deforming simultaneously with the melting and exiting from solder ejection outlet 74.

With this structure, slits 72a-72d go beyond the upper end (inflow end) of solder ball 32 retained from solder ejection outlet 74 (the tip of the nozzle), and extend to the upper side (inflow side). Solder ball 32 is exposed from top to bottom through slits 72a-72d. In this way with slits 72a-72d that extend from the inflow end of solder ball 32 to solder ejection outlet 74, contact between surface of the molten solder. Accordingly, solder ball retention unit 7 (nozzle 21) is reduced, making it less likely that there will be blockage in solder ball retention unit 7 (nozzle 21).

With these slit shapes, inert gas flowing out from slits 72a-72d is able to effectively flow over solder ball 32 and connecting parts 121, 144. In this way it is possible to surround solder ball 32 and connecting parts 121, 144 with inert gas. Thus, a proper connection is formed between connecting parts 121, 144 in an atmosphere of inert gas as the melting of the solder and the bonding occur with solder ball 32.

Slits 72a-72d thus act as the outflow aperture for the inert gas, enabling inert gas to be supplied to nozzle 21 prior to irradiation with a laser beam (before the solder melts) and enabling the solder to be ejected simultaneously with the melting of the solder. Moreover, as the inert gas within nozzle 21 flows around the solder ball, it is possible to suppress oxidization of the solder. Furthermore, the inert gas flowing out from slits 72a-72d flows over solder ball 32 and connecting parts 121, 144, enabling connecting parts 121, 144 to be connected together by molten solder in an atmosphere of inert gas.

In addition to reducing contact surfaces for the molten solder, slits are formed over a wide area from the solder ejection outlet 74 to the inlet position for solder ball 32 as shown in the slit shapes shown in FIG. 7A-7E. This ensures the area surrounding solder ball 32 and connecting parts 121, 144 is filled with inert gas. However, to expel the solder almost simultaneously with the melting, slits may be formed in positions and shapes different to those shown in slits 72a-72d in FIG. 7A-7E. Moreover, they may also be formed in positions and shapes different to those of slits 72a-72d to ensure reduction in the contact surface area and to prevent oxidization.

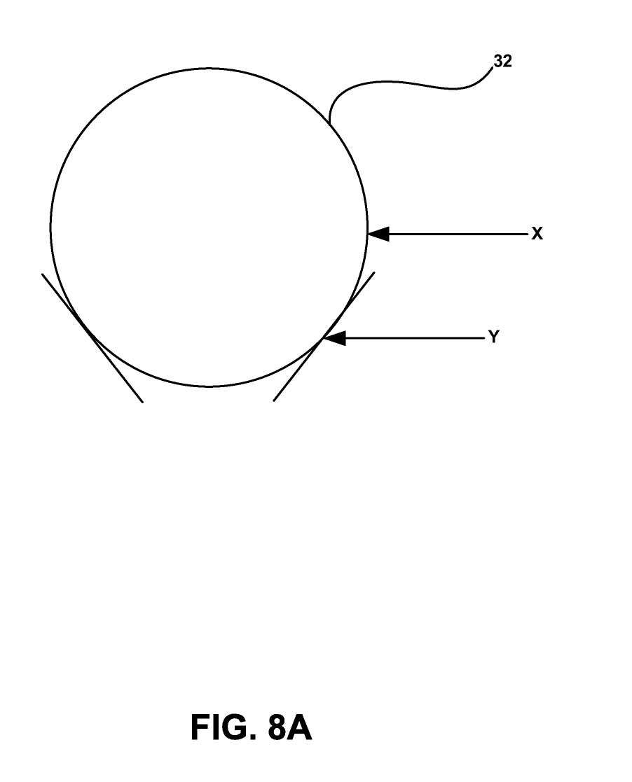

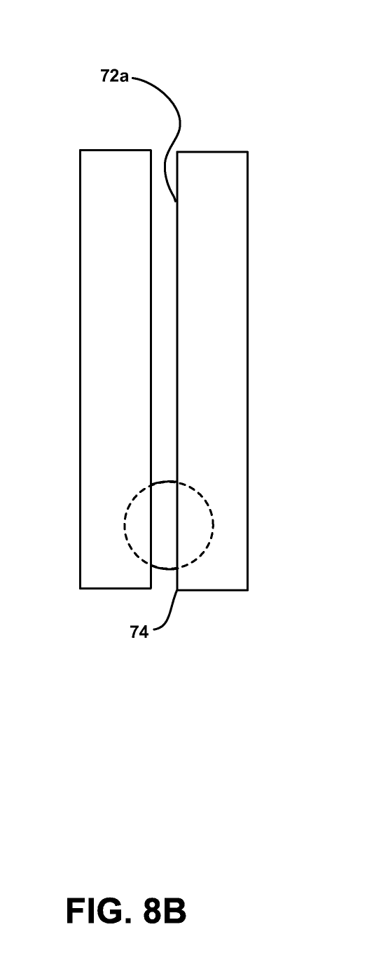

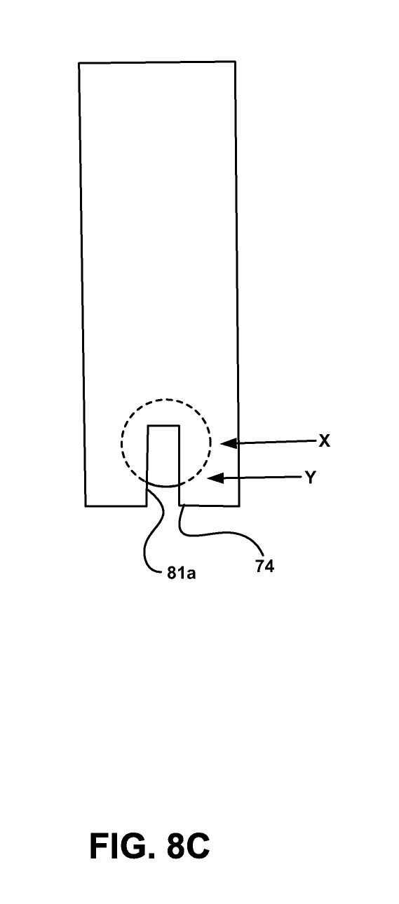

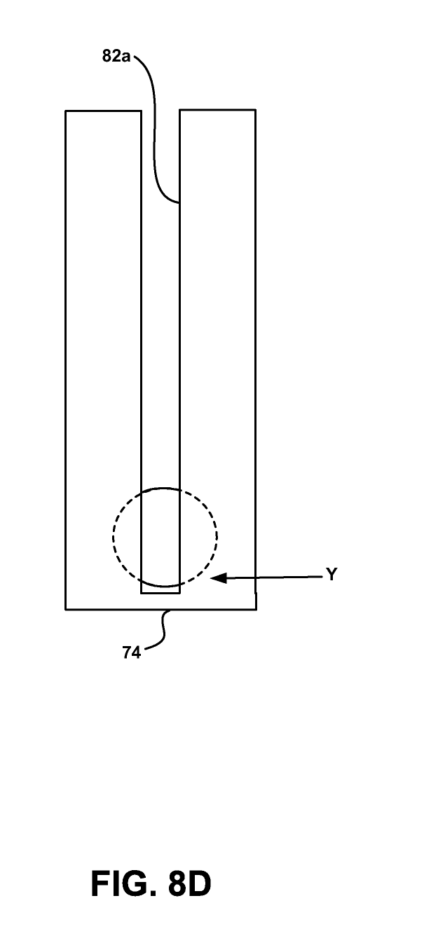

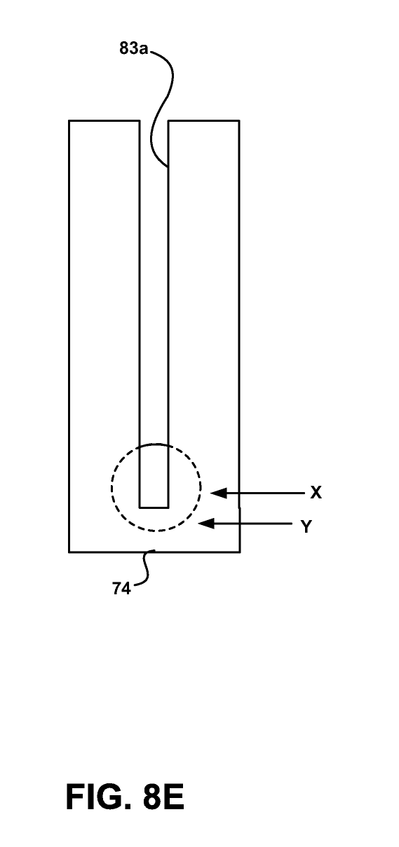

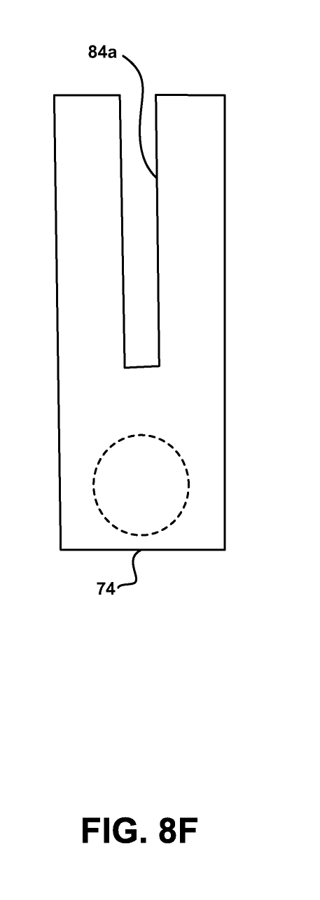

FIG. 8A is a cross-section schematically illustrating the support points for solder ball 32 as it is retained within solder ball retention unit 7. FIGS. 8B-8E illustrate lateral schematic views of five examples of outflow apertures for inert gas formed in nozzle 21. Solder ball 32 is retained by claws 71a-71d more towards the position Y on the outflow side (downflow side) rather than position X in the center of its surface in the vertical direction.

To allow inert gas to flow out effectively from the apertures (slits), the apertures (at least part of them) are be formed at support position X of solder ball 32 or in a region above this. The examples of the structure shown in FIG. 8B-8F provide for this condition.

FIG. 8B is the same as the lateral view shown in FIG. 7D. FIG. 8C shows a lateral view of another structure. Slit 81a extends to a position which extends from solder ejection outlet 74 beyond position X. The upper end of slit 81a (inflow end) is positioned below (outflow side) the top of solder ball 32 (inflow end). The other three slits have the identical structure. As the upper end of the slit is positioned below the top of the solder ball, efficiency is lower than that shown for the structures in FIG. 7A-7E, but this slit shape is effective in reducing the contact surface area and preventing oxidization of the solder.

To reduce the contact area for the molten solder and prevent the nozzle from blocking, the slits include a region from solder ball support position X to solder ejection outlet 74, as shown in this structure (and the structures in FIG. 7A-7E). By this means it is possible to effectively prevent contact with surfaces when the molten solder flows downwards. In addition, as the gap between solder ball 32 and the pathway is at a minimum at center position X, slit extends vertically to include this position to allow inert gas to flow downward effectively. Structures other than the structure shown in FIG. 8F satisfy this condition.

FIG. 8D is a lateral view of another structure. Slit 82a extends beyond the upper end of solder ball 32 from between solder ejection outlet 74 and solder ball support position Y. The other slits have identical configurations. In one embodiment, these slits extend as far as solder ejection outlet 74. As a result, this reduces contact surfaces for the molten solder. Blockages can be effectively prevented in this structure as well, with the region from slit 82a from the top to bottom of solder ball 32 exposed. Furthermore, solder ball 32 and connecting parts 121, 144 can be surrounded with an inert gas atmosphere.

FIG. 8E shows a lateral view of another structure. Slit 83a extend beyond the top of solder ball 32 from between solder ball support position Y and central position X. The other slits have identical configurations. The bottom of solder ball 32 is not exposed from slit 83a, but the upper part of solder ball 32 is partially exposed above from between solder ball support position Y and central position X. Compared to the structures described thus far, the contact area is increased, but it is possible to ensure the supply of inert gas in the retained state, and to suppress the oxidization of the solder.

FIG. 8F is a lateral view of another structure. Slit 84a is formed on the upper side from above the top of solder ball 32. The other slits have identical configurations. This slit shape also allows inert gas to flow out from slit 84a, and with the supply of inert gas commencing with the solder ball retained before being irradiated with the laser beam, enabling the solder to be ejected at the same time as the solder melts. Moreover, the inert gas can be made to flow towards connecting parts 121, 144.

The slits of the solder ball retention unit are typically the same shape. However, slits of differing shapes may be formed. In one embodiment, at least two of the plurality of slits are formed so as to face each other across the pathway. In other words, at least two of the plurality of slits are aligned in the perpendicular direction with direction of drop at the center of the pathway.

As described with reference to FIG. 2, soldering device 2 photographs the retained solder ball using camera 27. In such an embodiment, two facing slits are provided on the line connecting camera 27 and solder ball. Accordingly, it is possible for soldering device 2 to reliably confirm the number of balls and their state of retention.

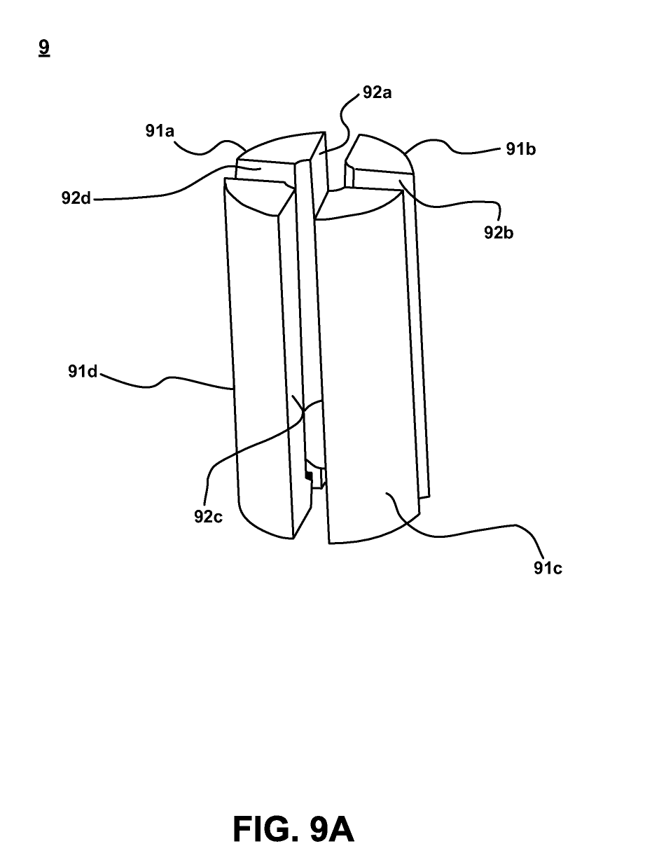

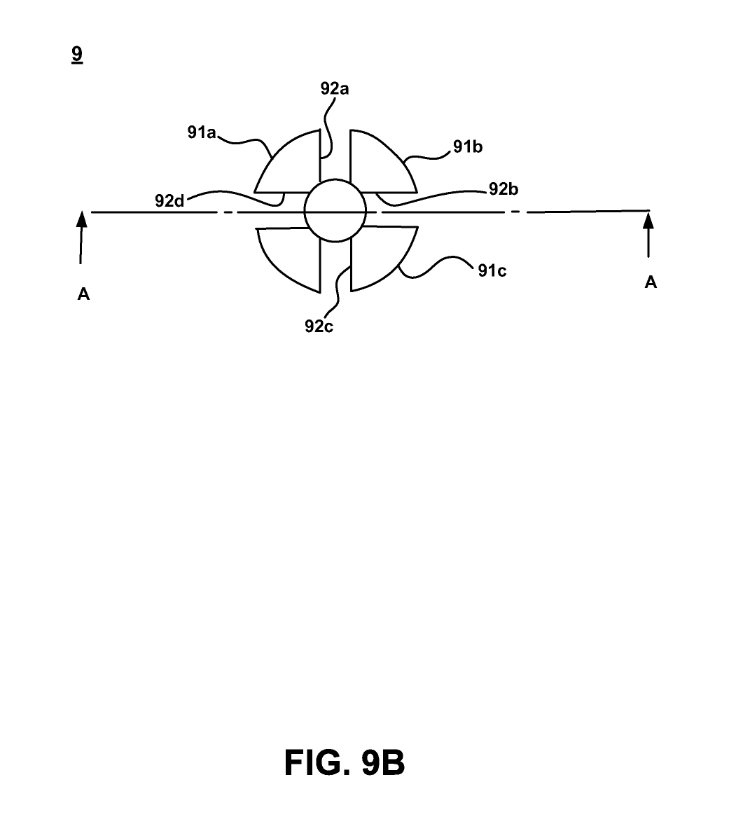

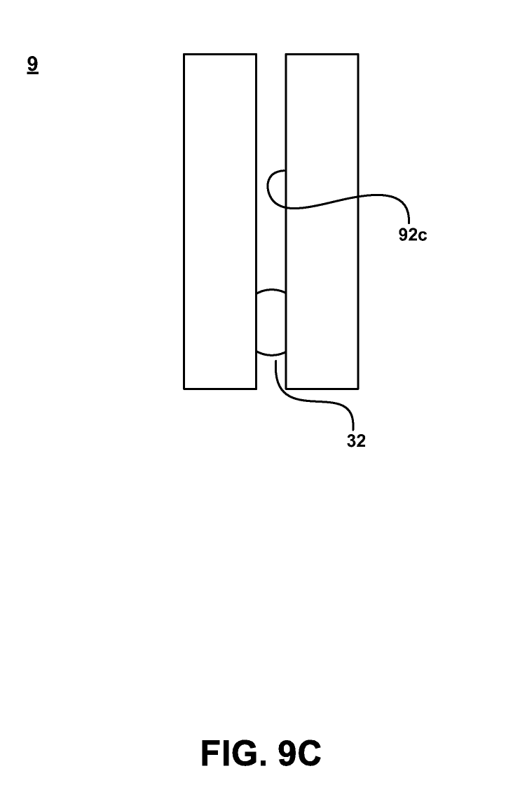

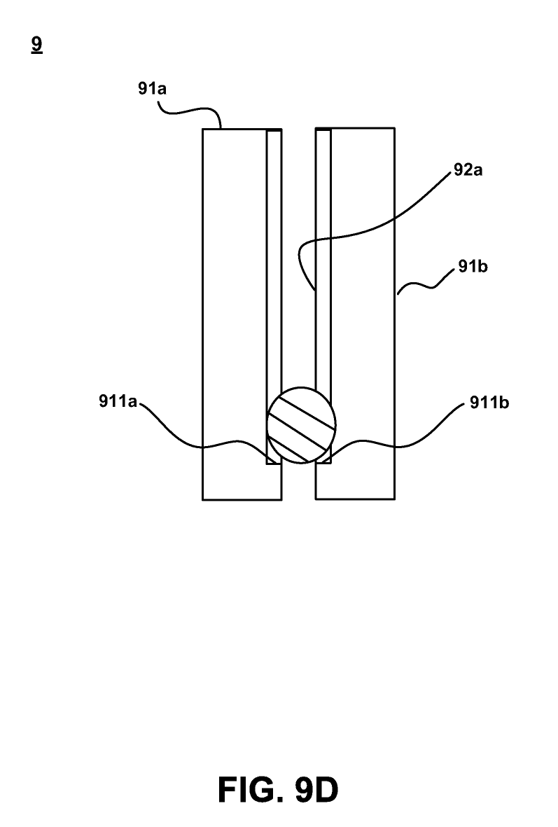

The content described in FIGS. 8A-8F can be applied to other solder ball retention unit structures to be described below. FIGS. 9A-9D are schematic diagrams illustrating a plurality of solder ball retention units 9 having other structures. FIGS. 9A-9D are respectively an oblique view, a plan view, a lateral view and a cross-section through the line A-A in the plan view of solder ball retention unit 9.

Solder ball retention unit 9 is provided with four claws 91a-91d. These four claws 91a-91d are separated by slits (apertures) 92a-92d formed between these. As the structure of solder ball retention unit 9 is similar to the structure of solder ball retention unit 7, a description will be given of the differences. The inner surfaces of claws 91a-91d are curved surfaces, with the cross-section of the pathway these form being a circle (excluding slits 92a-92d). Moreover, the outer surfaces of claws 91a-91d are also curved, so that solder ball retention unit 9 is approximately cylindrical.

The solder ball support surfaces 911a-911b for claws 91a-91d are not sloping surfaces but horizontal surfaces which project to the inside. The retaining surface for solder ball 32 is the bottom of the pathway. The retained solder ball 32 is in contact with the angles of the horizontal surfaces of claws 91a-91d, and is retained there. As described above, retaining surfaces are sloping surfaces to allow the molten solder to flow effectively. However, from the point of view of ease of manufacture for the solder ball retaining unit, a horizontal retaining surface is effective.

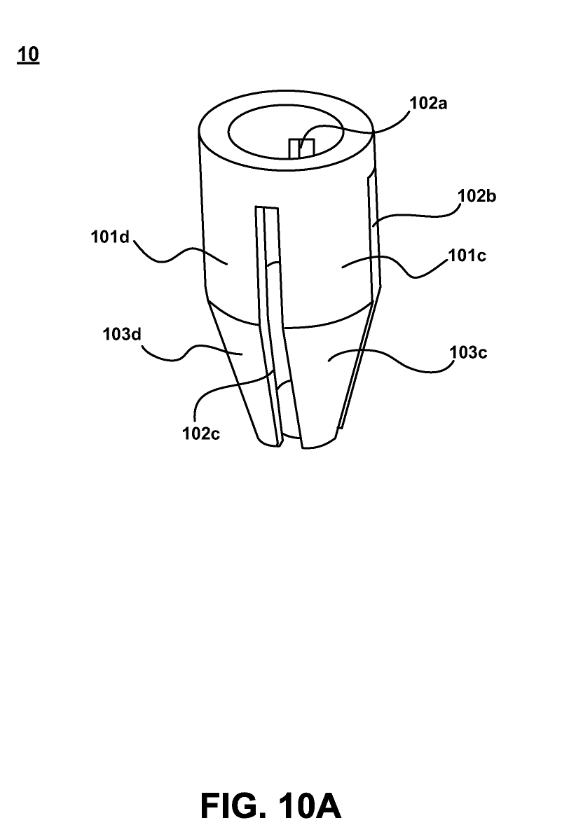

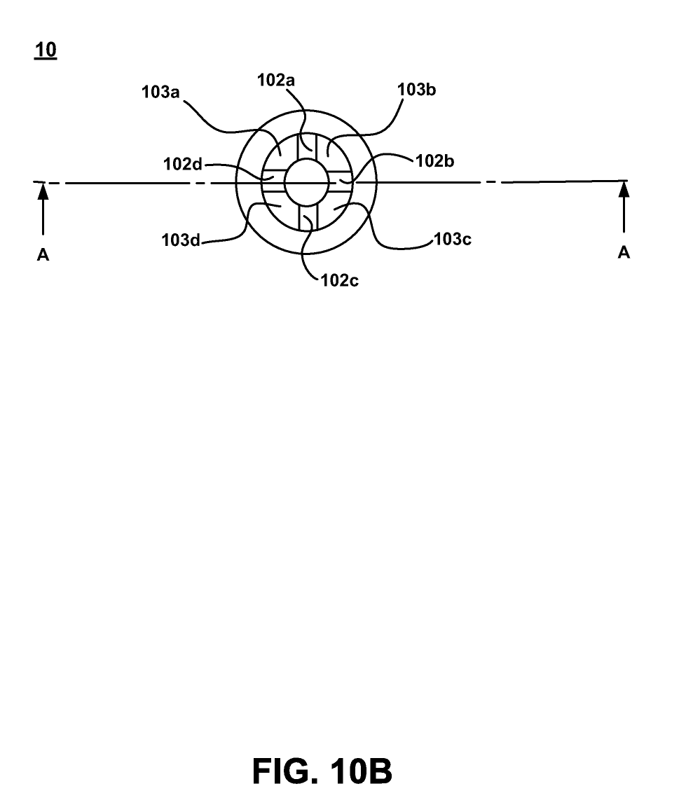

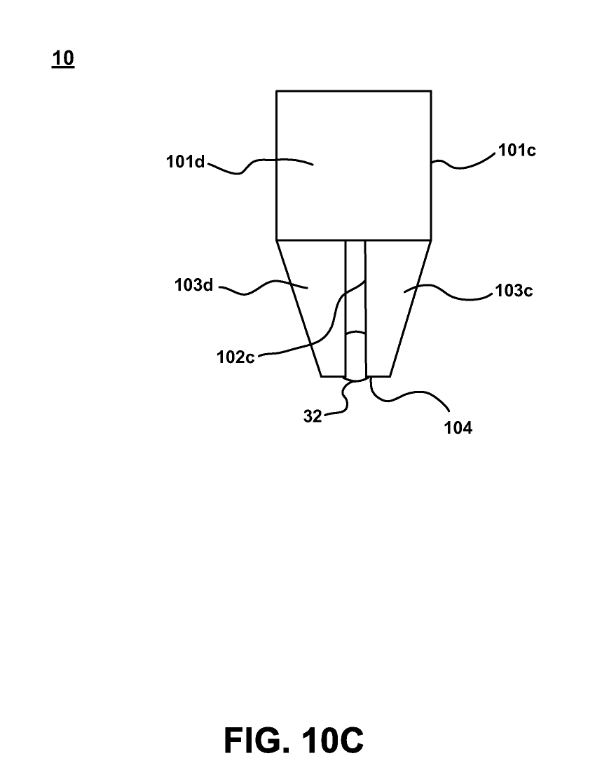

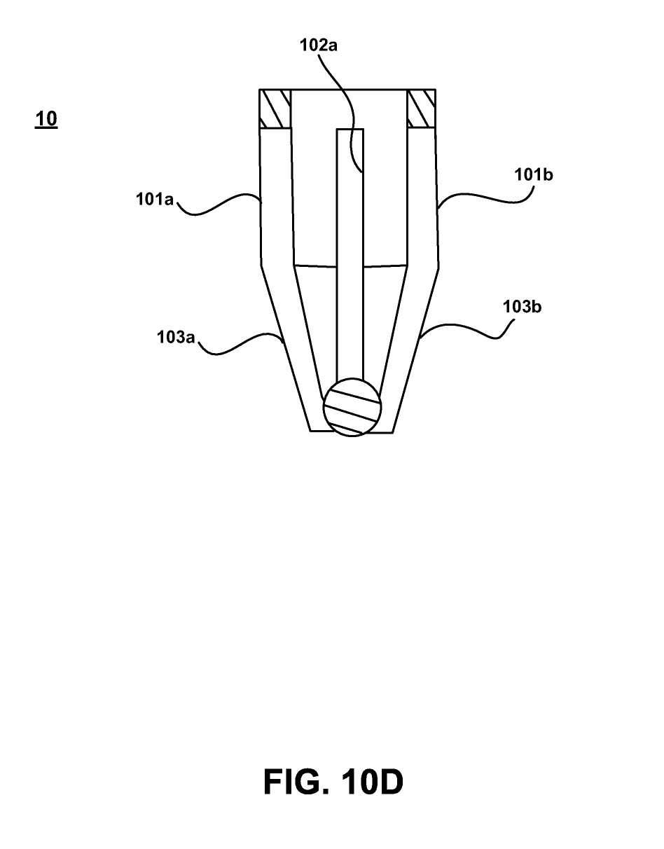

FIGS. 10A-10D schematically illustrate a plurality of views of solder ball retention unit 10 with another structure. FIGS. 10A-10D are respectively an oblique view, a plan view, a lateral view, and a cross-section through the line A-A of the plan view of solder ball retention unit 10. The overall external shape of solder ball retention unit 10 is roughly cylindrical, with its tip gradually narrowing. In other words, at the tip of solder ball retention unit 9 its internal and external radius gradually reduces towards the outflow end from the inflow end (a tapered shape).

Solder ball retention unit 10 is provided with four claws 101a-101d. The four claws 101a-101d are separated by slits (apertures) 102a-102d formed between these in the peripheral direction. The four claws 101a-101d have their side parts 103a-103d bent inward. This claw shape allows the pathway to gradually reduce towards solder ejection outlet 104, and solder ball 32 stops and is retained in the position where its minimum diameter is smaller than the diameter of the solder ball. The inner surfaces of parts 103a-103d on the outflow side are bent in the horizontal direction, and the contact with solder ball 32 is linear.

Slits 102a-102d extend to solder ejection outlet 104 (the tip) from a position above the top of the retained solder ball 32. With this slit shape it is possible to have an identical effect to that of the structure described with reference to FIGS. 7A-7E. Solder ball 32 is in contact with the sloping surfaces (tapered surfaces) as they approach the center going from the outflow side to the inflow side, and is retained there. As the compressed gas makes it easy for the molten solder to flow towards the outside, blockage within solder ball retention unit 10 is unlikely to occur.

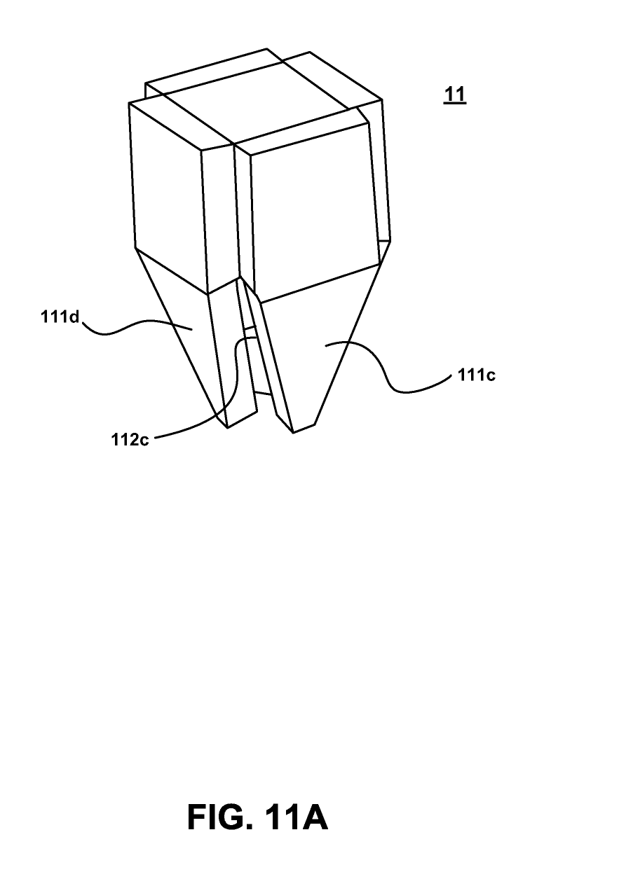

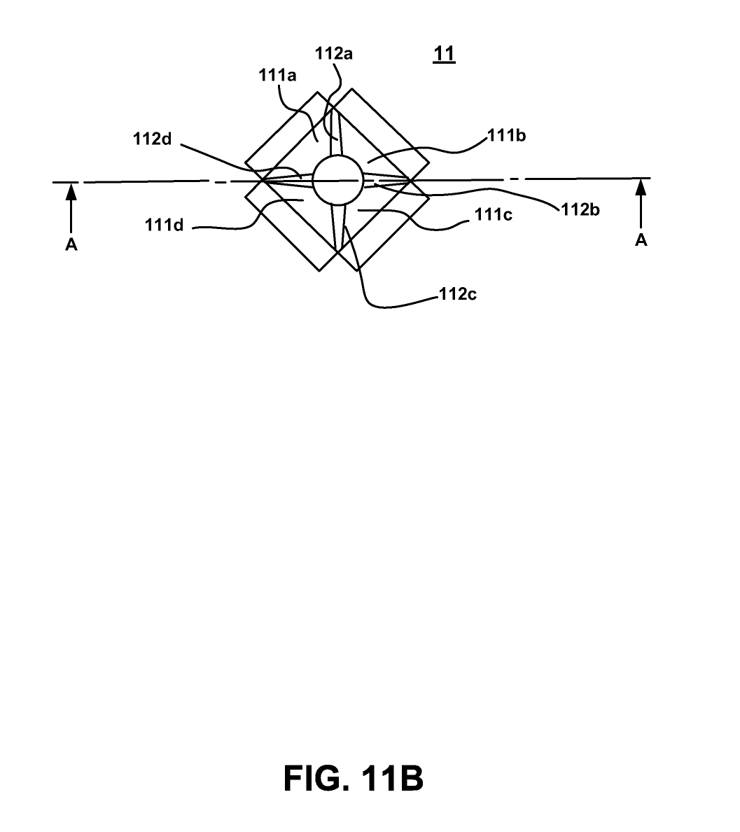

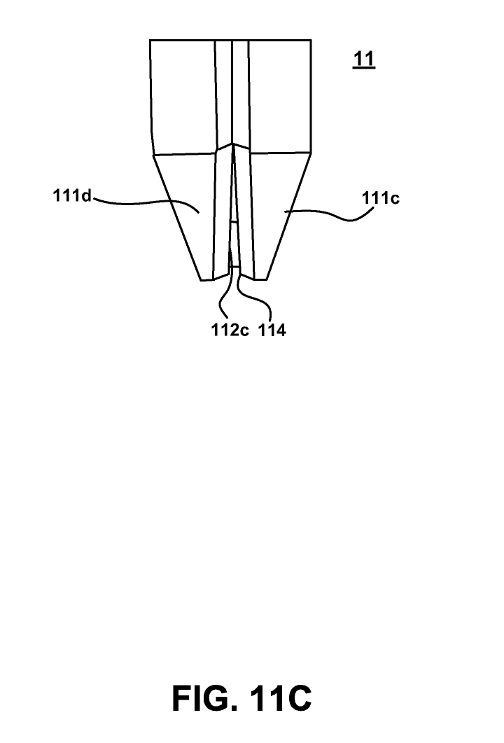

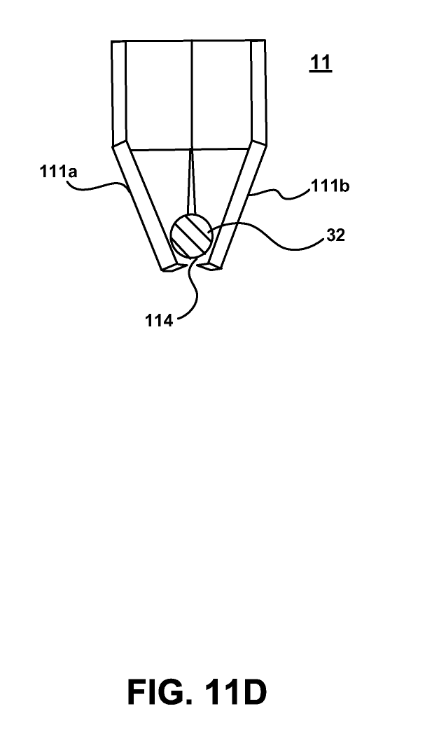

FIGS. 11A-11D schematically illustrate a plurality of views of solder ball retention unit 11 with another structure. FIG. 11A-11D are respectively an oblique view, a plan view, a lateral view and a cross-section through the line A-A of the plan view of solder ball retention unit 11. Solder ball retention unit 11 is provided with four claws 111a-111d. The four claws 111a-111d are separated by slits (apertures) 112a-112d formed between these in the peripheral direction.

This solder ball retention unit 11 has a structure similar to that of solder retention unit 10. The outer surfaces and inner surfaces of claws 111a-111d are plane surfaces, the difference being that with solder ball retention unit 10 the outer surfaces and inner surfaces of parts 103a-103d on the outflow side are curved surfaces. As the inside surfaces to which solder ball 32 is in contact are plane surfaces, the contact between solder ball 32 and the inner surfaces of the claws is a point contact.

Slits 112a-112d of solder ball retention unit 11 are formed in the range from solder ejection outlet 114 (tip) to the upper end of claws 111a-111d. With this slit shape, slits are formed from above the top of the retained solder ball 32, and in terms of the effect of the inert gas flow a similar effect is obtained to solder ball retention unit 7 described with reference to FIG. 7A-7E. The rest of the structure is effectively identical to solder ball retention unit 10.

It should be appreciated that descriptions of nozzles with different structures have been given with reference to different drawings, but these elements may be applied separately or used in combination.

Embodiments of the present invention are particularly useful in the manufacture of an HGA than HDD, but may also be applied to an HGA used in other disk drives. Embodiments of the present invention can also be used to make connections within the HGA in addition to making connections between the head slider, micro-actuator and suspension. Moreover, the number of contact points between the connections may vary with the design of the HGA. Furthermore, connections between the connecting parts may be made by melting a piece of metal with a shape other than a sphere where this does not present problems with transportation.

1. A method for connecting electrical parts, said method comprising:
retaining a piece of metal within a nozzle;
supplying inert gas to the nozzle;
irradiating the retained piece of metal with a light source while the supplied inert gas flows from apertures in the nozzle, wherein the metal is melted by the light source; and
ejecting the melted metal from the nozzle by the supplied inert gas onto electrical parts.

2. The method of claim 1, wherein the inert gas flows from the apertures in the direction of the electrical parts.

3. The method of claim 1, wherein the inert gas flows from the apertures, wherein the apertures are formed at a support position of the piece of metal.

4. The method of claim 1, wherein the inert gas flows from the apertures which extend to an ejection outlet.

5. The method of claim 1, wherein the irradiating the retained piece of metal with a light source comprises:
irradiating the retained piece of metal with a laser.

6. The method of claim 1, wherein said retaining the piece of metal within the nozzle comprises:
retaining the piece of metal on surfaces within the nozzle, wherein the surfaces slope in the direction of an ejection outlet.

7. The method of claim 1, wherein said retaining the piece of metal within the nozzle comprises:
retaining the piece of metal by a plurality of claws separated by a plurality of apertures extending to an ejection outlet.

8. The method of claim 1, further comprising:
transporting the piece of metal to the nozzle through a transportation pipe.

9. The method of claim 1, further comprising:
connecting the electrical parts together through hardening of the melted metal.

10. A device comprising:
a nozzle comprising:
a retaining section configured to retain the piece of metal transported from the transportation section;
an ejection outlet configured to eject the piece of metal towards electrical parts; and
apertures configured to allow an inert gas to flow from.
an inert gas supply device configured to supply the inert gas into the nozzle; and
an irradiation device configured to irradiate and melt the piece of metal as the inert gas flows from the apertures.

11. The device of claim 10, further comprising:
a transportation section configured to transport the piece of metal.

12. The device of claim 10, wherein the apertures are formed at location where the piece of metal and an inner surface of the nozzle are in contact.

13. The device of claim 10, wherein the apertures extend to an ejection outlet.

14. The device of claim 10, wherein the nozzle further comprises:
sloped surfaces within the nozzle, wherein the sloped surfaces slope in the direction of an ejection outlet.

15. The device of claim 10, wherein the nozzle further comprises:
a plurality of claws configured to retain a solder ball, wherein the plurality of claws are separated by the apertures extending to an ejection outlet.

16. The device of claim 10, further comprising:
a camera configured for viewing a solder ball through said nozzle.

17. The device of claim 10, wherein said nozzle is transparent.

18. The device of claim 10, wherein said piece of metal is a solder ball.

19. A method for manufacturing a head gimbal assembly, said method comprising:
retaining a solder ball within a nozzle;
supplying inert gas to the nozzle;
irradiating the retained solder ball with a laser while the supplied inert gas flows from apertures in the nozzle, wherein the solder ball is melted by the laser; and
ejecting the melted metal from the nozzle by the supplied inert gas onto electrical parts onto electrical parts of a head gimbal assembly.

20. The method of claim 19, wherein the ejecting the melted metal from the nozzle by the supplied inert gas onto electrical parts onto electrical parts of a head gimbal assembly comprises:
ejecting the melted metal from the nozzle by the supplied inert gas between a portion of a slider and a portion of a suspension of a head gimbal assembly.
